(19) United States
(12) Patent Application Publication
(10) Pub. No.: US 2023/0267441 A1
(43) Pub. Date: Aug. 24, 2023

(54) PAYMENT MACHINE AND PAYMENT MACHINE METHOD

(71) Applicant: Toshiba Tec Kabushiki Kaisha, Tokyo (JP)

(72) Inventor: Hidenori Fujimaki, Mishima Shizuoka (JP)

(21) Appl. No.: 18/074,242

(22) Filed: Dec. 2, 2022

(30) Foreign Application Priority Data
Feb. 22, 2022 (JP) 2022-025850

(51) Int. Cl. G06Q 20/22; G06Q 20/38; G06Q 20/28

(52) U.S. Cl. CPC G06Q 20/227; G06Q 20/387; G06Q 20/28

(57) ABSTRACT

A payment machine has a processor connected to a display. The processor receives settlement data relating to a sales transaction and controls the display to show a first screen for selection of a payment method when the settlement data indicates the customer cannot use a member-specific payment method. The processor shows a second screen for accepting a designation to use the member-specific payment method or not if the settlement data indicates the customer can use the member-specific payment method and a third screen for accepting the member-specific payment method if the customer selects the member-specific payment method or the first screen if the customer does not select the member-specific payment method.

### CROSS-REFERENCE TO RELATED APPLICATION

This application is based upon and claims the benefit of priority from Japanese Patent Application No. 2022-025850, filed Feb. 22, 2022, the entire contents of which are incorporated herein by reference.

### FIELD

An embodiment described herein relates to a payment machine for a product checkout system and a method therefor.

### BACKGROUND

In recent years, a semi-self-service-type checkout system has been introduced at mass retailers such as supermarkets. Such a checkout system has a product registration machine (registration terminal) used for registering an item of merchandise being purchased by a customer that is separated from a payment machine (settlement terminal) used for accepting the payment for the purchased merchandise and settling the sales transaction. Thus, typically the salesclerk operates the product registration machine and then the customer separately operates the payment machine.

Some payment machines are of a type that support not only payment by cash but also various other payment methods such as payment by electronic money and/or payment with “points.” In this context, “points” refers to accumulated benefits/rewards associated with, for example, a customer loyalty program or the like. Such a payment machine displays a payment method selection screen on a display device such as a touch panel and prompts a customer to select a payment method. Then, after one of the payment methods is selected, the payment machine accepts the payment for purchased merchandise according to that selected payment method and executes settlement processing for the sales transaction.

A “payment with points” is a method of settling a transaction by converting points collected by the customer who is a points program member (“point member”) into cash equivalent value or the like. Points are generally given by a store only for a sales transaction with a registered point member. The points given to a customer are generally considered outstanding debts of the store until used for payment or the like. In view of such circumstances, the store usually has a preference that payments be made with points whenever possible.

### BRIEF DESCRIPTION OF THE DRAWINGS

FIG. 1 is a schematic view of a checkout system.

FIG. 2 is a schematic view showing a main data structure of a member record.

FIG. 3 is a block diagram of a registration machine.

FIG. 4 is a block diagram of a payment machine.

FIG. 5 is a flowchart of first information processing executed by a processor of a registration machine according to a registration program.

FIG. 6 is a flowchart of member data processing.

FIG. 7 is a flowchart of second information processing executed by a processor of a payment machine.

FIG. 8 is a display example of a payment method selection screen.

FIG. 9 is a display example of a payment-with-points prompt screen.

FIG. 10 is a display example of a payment-with-points screen.

FIG. 11 is another display example of a payment method selection screen.

### DETAILED DESCRIPTION

In general, according to one embodiment, a payment machine that can prompt the use of a member-specific payment method, such as reward points-based settlement, for retail customer transactions is provided.

According to one embodiment, a payment machine includes a display screen for displaying screens related to settlement of a sales transaction to a customer and a processor. The processor is connected to the display screen and configured to: receive settlement data relating to a sales transaction; control the display screen to display a first screen for accepting a selection of a payment method from among a plurality of payment methods if the settlement data indicates the customer cannot use a member-specific payment method; control the display screen to display a second screen for accepting a designation to use the member-specific payment method or not if the settlement data indicates the customer can use the member-specific payment method; control the display screen to display a third screen for accepting payment by the member-specific payment method if the customer designates use of the member-specific payment method on the second screen; and control the display screen to display the first screen if the customer designates not to use the member-specific payment method on the second screen.

Hereinafter, an example embodiment of a payment machine will be described using the drawings. In the example, the payment machine is used in a semi-self-service-type checkout system for a retail store, but embodiments are not necessarily limited thereto.

### DESCRIPTION OF CHECKOUT SYSTEM

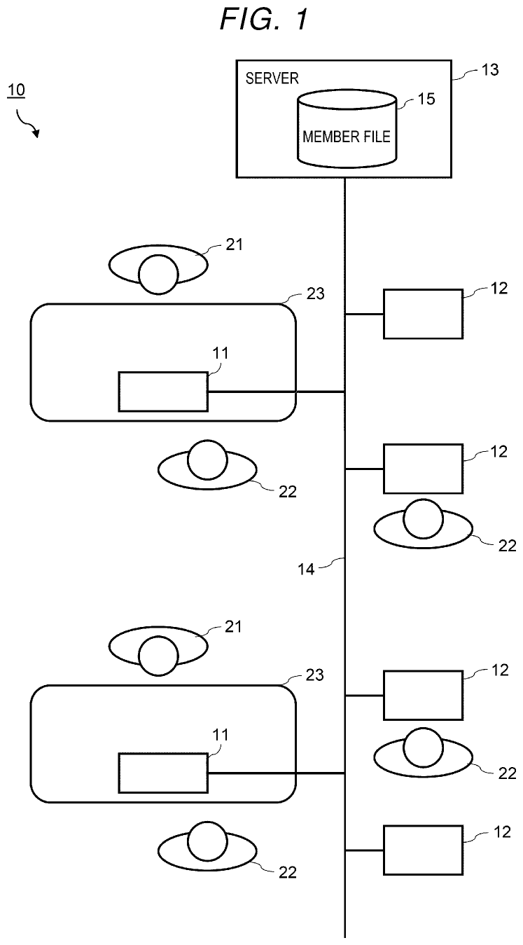

FIG. 1 is a schematic configuration of a checkout system 10 according to an embodiment. The checkout system 10 includes a registration machine 11, a payment machine 12, a server 13, and a network 14 connecting these. The type of the network 14 is not particularly limited, but generally a wired or wireless LAN (local area network) is applied.

A salesclerk 21 (playing a role called checker) is the operator of a registration machine 11. A customer 22 purchasing merchandise at the store is the operator of the payment machine 12. The customer 22 operating the payment machine 12 and settling a sales transaction can be referred to as a settler or payor. While the present example concerns merchandise transactions, the sales transaction is not limited to the purchase of goods and the settlement process in other examples may relate to payments for a service or combinations of goods and services.

In FIG. 1, the registration machine 11 is shown installed on a work table 23. The work table 23 has a rectangular top board. A plurality of work tables 23 can be arranged in such a way that the longitudinal directions of the top boards are substantially parallel such that an aisle for the customer 22, a so-called checkout lane, is formed.

One registration machine 11 and one payment machine 12 can be arranged on a per checkout lane basis. In the depicted example, each checkout lane is provided with one registration machine 11 and two payment machines 12. Additional, payment machines 12 may be provided in some examples. Between the registration machine 11 and the payment machine(s) 12 arranged for the same checkout lane, various data signals are transmitted and received via the network 14. The data signals may be transmitted and received via the server 13 or directly (not via the server 13).

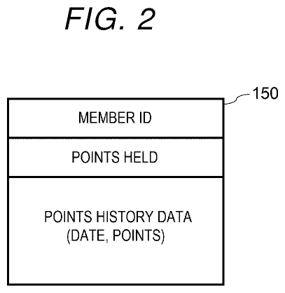

The server 13 has a member file 15. The member file 15 is an aggregate of member records 150 (see FIG. 2) generated on a per member basis for each registered member. In this context, a “member” is a person who has registered to participate in a points program (e.g., customer loyalty program) and may be referred to as a point member. The member file 15 may be saved in a memory device built in the server 13 or may be saved in a memory device externally connected to the server 13.

FIG. 2 is a schematic view showing a main data structure of a member record 150. The member record 150 includes items such as a member ID, a points held value, and points history data. The member ID is a unique code set on a per member basis in order to identify each individual point member. For example, the point member is provided with a member card with the point member's own member ID recorded therein/thereon. Alternatively, the point member may have application software installed on a portable terminal such as a smartphone that is able to display a barcode or a two-dimensional code linked to the point member's member ID. When paying for purchased merchandise, the point member presents the member card, the portable terminal or the like to the salesclerk 21 operating the registration machine 11 and notifies the salesclerk 21 of the member ID. The salesclerk 21 registers (e.g., scans or otherwise enters) the member ID at the registration machine 11 and declares that the present transaction is a sales transaction with a point member.

The points held are accumulated points currently held by the point member identified by the member ID. By selecting payment with points as the settlement payment method, the point member can, for example, convert 1 point into 1 yen of value, and thus use the accumulated points for the payment of the price of merchandise. However, of course, the rate of conversion is not limited “1 point->1 yen”. Depending on store preferences, the option for payment with points might be available only to a point member holding a predetermined number of points or more, for example, 100 points or more, or 1000 points or more.

The points history data reflects the history of points being added and subtracted according to prior transactions for the point member and may be referred to as a points balance history or the like. The history data includes the date when points were given and the number of points given on that date as well as the date when a payment with points was made and the number of points used on that date.

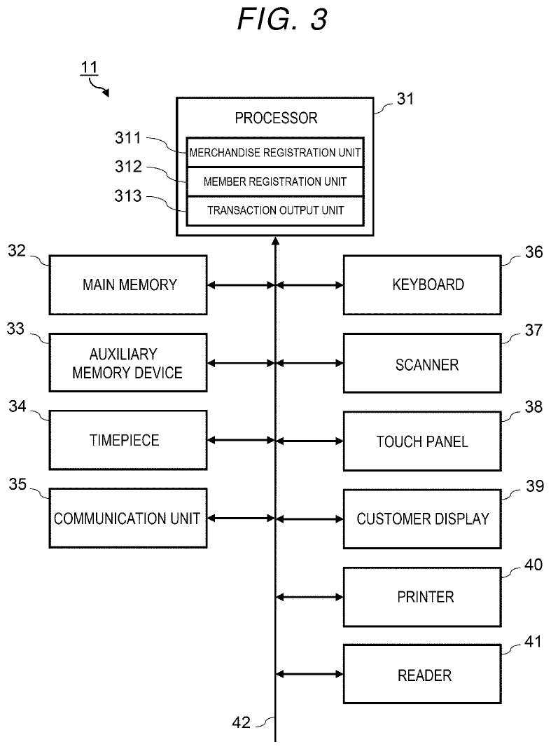

Description of Registration Machine FIG. 3 is a block diagram of a registration machine 11. The registration machine 11 has a processor 31, a main memory 32, an auxiliary memory device 33, a timepiece 34, a communication unit 35, a keyboard 36, a scanner 37, a touch panel 38, a customer display 39, a printer 40, a reader 41, and a system transmission path 42 or the like. The system transmission path 42 includes an address bus, a data bus, a control signal line, or the like. The system transmission path 42 couples the processor 31 and each of the other parts directly or via a signal input-output circuit and transmits data signals transmitted and received between these.

The registration machine 11 has the processor 31, and the main memory 32, the auxiliary memory device 33, the timepiece 34 and the communication unit 35 coupled to each other via the system transmission path 42. Also, the registration machine 11 has a device such as the keyboard 36, the scanner 37, the touch panel 38, the customer display 39, the printer 40, and the reader 41 coupled via the system transmission path 42.

The processor 31 controls each part in order to implement various functions of the registration machine 11 according to an operating system and/or an application program. The processor 31 is, for example, a CPU (central processing unit).

The main memory 32 includes a non-volatile memory area and a volatile memory area. The main memory 32 stores an operating system and/or an application program in the non-volatile memory area. In some cases, the main memory 32 may store necessary data for the processor 31 to execute processing to control each part, in the non-volatile or volatile memory area. The main memory 32 uses the volatile memory area as a work area where data is rewritten by the processor 31 when appropriate. The non-volatile memory area is, for example, a ROM (read-only memory). The volatile memory area is, for example, a RAM (random-access memory).

For example, an EEPROM (electrically erasable programmable read-only memory), an HDD (hard disk drive), or an SSD (solid-state drive) or the like can be the auxiliary memory device 33. In the auxiliary memory device 33, data used by the processor 31 to execute various kinds of processing, data generated through processing by the processor 31, or the like, is saved. In some cases, the auxiliary memory device 33 may store an application program.

The timepiece 34 tracks date and time. The processor 31 processes the date and time tracked by the timepiece 34, as the current date and time.

The communication unit 35 performs data communication with the server 13 and the payment machine 12 connected via the network 14. The communication unit 35 can also perform data communication with another registration machine 11 connected via the network 14.

The keyboard 36 is an input device where various keys that are necessary to input data relating to merchandise purchased by a customer are arranged.

The scanner 37 is an input device for reading a code symbol such as a barcode or a two-dimensional code. The scanner 37 may be of a type that reads a code symbol by scanning with a laser beam or may be a type that reads a code symbol from an image picked up by an image pickup device.

The touch panel 38 is an apparatus having both an input device and a display device. The touch panel 38 performs the display of information to the salesclerk 21 who is the operator of the registration machine 11 and accepts an operation input by the salesclerk 21.

The customer display 39 performs the display of information to the customer 22 whose data of a purchased merchandise is registered at the registration machine 11.

The printer 40 prints various character strings or images or the like on a receipt paper and thus dispenses a receipt. As the printer 40 of this type, for example, a thermal printer or a dot impact printer or the like can be used.

The reader 41 is an input device for reading the member ID of the point member. For example, if the member ID is recorded on an IC card, an IC card reader can be the reader 41. For example, if the member ID is recorded on an RFID (radio frequency identification) medium, an RFID reader or an RFID reader-writer can be the reader 41. If a barcode or a two-dimensional code linked to the member ID is displayed on the display of a portable terminal such as a smartphone, a scanner can be the reader 41. In this case, the scanner 37 may also function as the reader 41.

As the hardware of such a registration machine 11, for example, an existing POS terminal can be used. Also, the device coupled to the registration machine 11 is not limited to the keyboard 36, the scanner 37, the touch panel 38, the customer display 39, the printer 40, and the reader 41 shown in FIG. 3. A necessary device for the use of the registration machine 11 may be added and a part of the devices may be omitted.

In the registration machine 11 of such a configuration, the processor 31 has functions as a merchandise registration unit 311, a member registration unit 312, and a transaction output unit 313. The merchandise registration unit 311 is a function of performing registration processing of merchandise sales data relating to a purchased merchandise of the customer 22 who is the settler. The member registration unit 312 is a function of, if the customer is a point member, performing registration processing of data relating to the point member. The transaction output unit 313 is a function of generating a transaction file of the customer 22, based on the merchandise sales data registered by the merchandise registration unit 311, and outputs the transaction file to the payment machine 12. The transaction file is a data file describing merchandise sales data relating to a purchased merchandise of the customer 22 who is the settler and data of the total number of items and the total amount, and transaction identification data such as transaction number, date and time of transaction, or registration machine ID. The transaction file is an example of data relating a sales transaction with a settler.

Each of the functions as the merchandise registration unit 311, the member registration unit 312, and the transaction output unit 313 are implemented by first information processing executed by the processor 31 according to a registration program. The registration program is a kind of application program stored in the main memory 32 or the auxiliary memory device 33. The method for installing the registration program in the main memory 32 or the auxiliary memory device 33 is not particularly limited. The registration program can be recorded on a removable recording medium or the registration program can be distributed by communication via the network 14 and thus installed in the main memory 32 or the auxiliary memory device 33. The recording medium may be any form that can store a program and can be read by a device, such as a CD-ROM or a memory card.

Description of Payment Machine

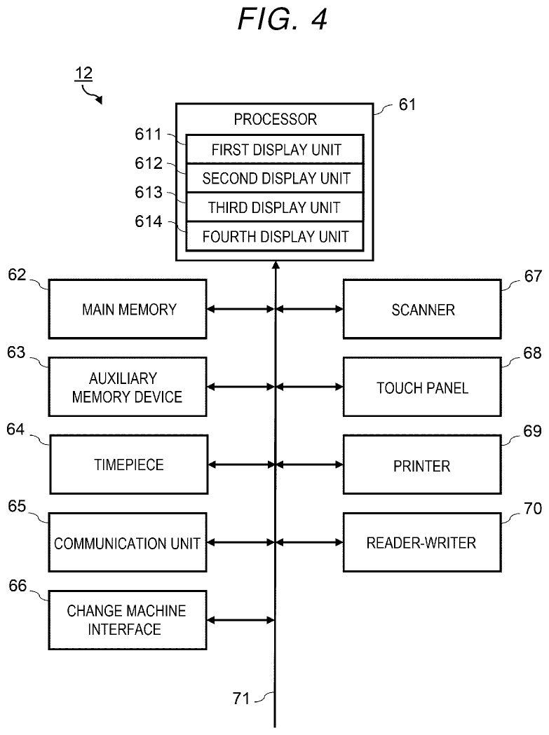

FIG. 4 is a block diagram of a payment machine 12. The payment machine 12 has a processor 61, a main memory 62, an auxiliary memory device 63, a timepiece 64, a communication unit 65, a change machine interface 66, a scanner 67, a touch panel 68, a printer 69, a reader-writer 70, and a system transmission path 71 or the like. The system transmission path 71 includes an address bus, a data bus, a control signal line, or the like. The system transmission path 71 couples the processor 61 and each of the other parts directly or via a signal input-output circuit and transmits data signals transmitted and received between these.

The payment machine 12 has the processor 61, and the main memory 62, the auxiliary memory device 63, the timepiece 64 and the communication unit 65 coupled to each other via the system transmission path 71. Also, the payment machine 12 has a device interface or a device such as the change machine interface 66, the scanner 67, the touch panel 68, the printer 69, and the reader-writer 70 coupled via the system transmission path 71.

The processor 61 controls each part in order to implement various functions of the payment machine 12 according to an operating system and/or an application program. The processor 61 is, for example, a CPU.

The main memory 62 includes a non-volatile memory area and a volatile memory area. The main memory 62 stores an operating system and/or an application program in the non-volatile memory area. In some cases, the main memory 62 may store necessary data for the processor 61 to execute processing to control each part, in the non-volatile or volatile memory area. The main memory 62 uses the volatile memory area as a work area where data is rewritten by the processor 61 when appropriate. The non-volatile memory area is, for example, a ROM. The volatile memory area is, for example, a RAM.

For example, an EEPROM, an HDD, or an SSD or the like can be the auxiliary memory device 63. In the auxiliary memory device 63, data used by the processor 61 to execute various kinds of processing, data generated through processing by the processor 61, or the like, is saved. In some cases, the auxiliary memory device 63 may store an application program.

The timepiece 64 tracks date and time. The processor 61 processes the date and time tracked by the timepiece 64, as the current date and time.

The communication unit 65 performs data communication with the server 13 and the registration machine 11 connected via the network 14. The communication unit 65 can also perform data communication with another payment machine 12 connected via the network 14. The communication unit 65 functions as an input unit for receiving data relating to a transaction file sent from the transaction output unit of the registration machine 11, that is, a sales transaction with a settler.

The change machine interface 66 provides an interface (connection) to an automatic change machine. The change machine interface 66 takes in amount data of money put into the automatic change machine, from the automatic change machine. The change machine interface 66 outputs change data from the payment machine 12 to the automatic change machine. The automatic change machine automatically dispenses money as change.

The scanner 67 is an input device for reading a code symbol such as a barcode or a two-dimensional code. The scanner 67 may be of a type that reads a code symbol by scanning with a laser beam or may be a type that reads a code symbol from an image picked up by an image pickup device.

The touch panel 68 combines an input device and a display device. The touch panel 68 performs the display of information to the customer 22 who is the operator of the payment machine 12 and accepts an input operation from the customer 22. The touch panel 68 functions as a display unit displaying a screen relating to the settlement of a sales transaction. The screen relating to the settlement of a sales transaction.

The printer 69 prints various character strings or images or the like on a receipt paper and thus dispenses a receipt. As the printer 69 of this type, for example, a thermal printer or a dot impact printer or the like can be used.

The reader-writer 70 has a function of reading data recorded on a medium such as a card or a smartphone, and a function of writing data on the medium. The card can include a member card referred to as a member's card, a point card or the like, as well as a card for settlement such as a credit card, a debit card, an electronic money card, or a prepaid card. The reader-writer 70 may be any one of a magnetic-type device, a contact-type device, and a contactless-type device, and may also include a plurality of types of devices.

As the hardware of such a payment machine 12, for example, a POS terminal in an existing full-self-service-type checkout system, a so-called self-service POS terminal, can be used. Also, the device coupled to the payment machine 12 is not limited to the scanner 67, the touch panel 68, the printer 69, and the reader-writer 70 shown in FIG. 4. A necessary device for the use of the payment machine 12 may be added and a part of the devices may be omitted.

In the payment machine 12 of such a configuration, the processor 61 has functions as a first display unit 611, a second display unit 612, a third display unit 613, and a fourth display unit 614. The first display unit 611 is a function of turning the screen on the touch panel 68 into a first screen accepting selection of one payment method from among a plurality of payment methods if the settler cannot use a member-specific payment method. In this embodiment, the member is a point member and the member-specific payment method is payment with points. The second display unit 612 is a function of turning the screen on the touch panel 68 into a second screen accepting a designation about whether to use the member-specific payment method or not, if the settler can use the member-specific payment method. The third display unit 613 is a function of turning the screen on the touch panel 68 into a third screen accepting payment by the member-specific payment method if a designation to use the member-specific payment method is accepted on the second screen. The fourth display unit 614 is a function of turning the screen on the touch panel 68 into the first screen if a designation not to use the member-specific payment method is accepted on the second screen.

Each of the functions as the first display unit 611, the second display unit 612, the third display unit 613, and the fourth display unit 614 are implemented by second information processing executed by the processor 61 according to a payment program. The payment program is a kind of application program stored in the main memory 62 or the auxiliary memory device 63. The method for installing the payment program in the main memory 62 or the auxiliary memory device 63 is not particularly limited. The payment program can be recorded on a removable recording medium or the payment program can be distributed by communication via the network 14 and thus installed in the main memory 62 or the auxiliary memory device 63. The recording medium may be any form that can store a program and can be read by a device, such as a CD-ROM or a memory card.

First and Second Information Processing

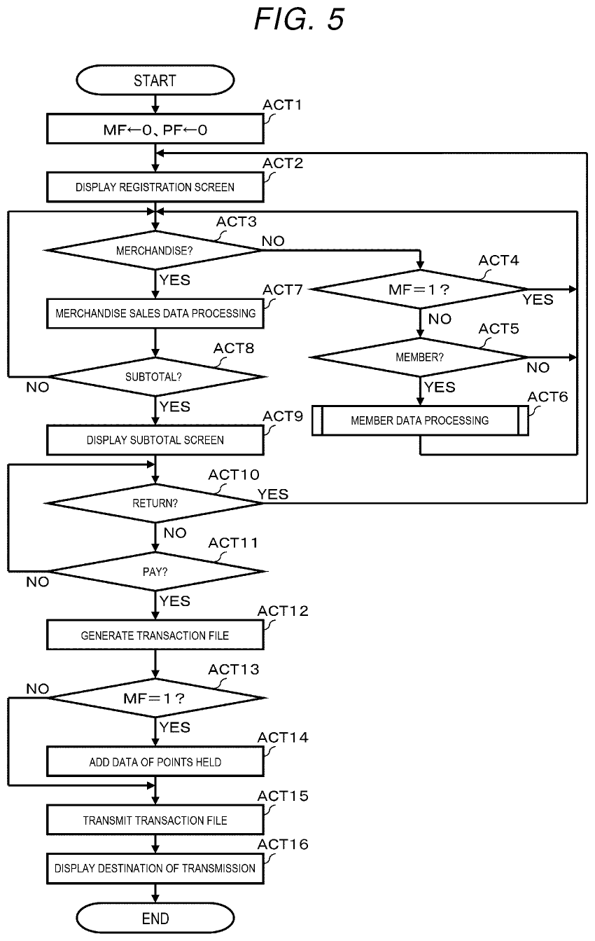

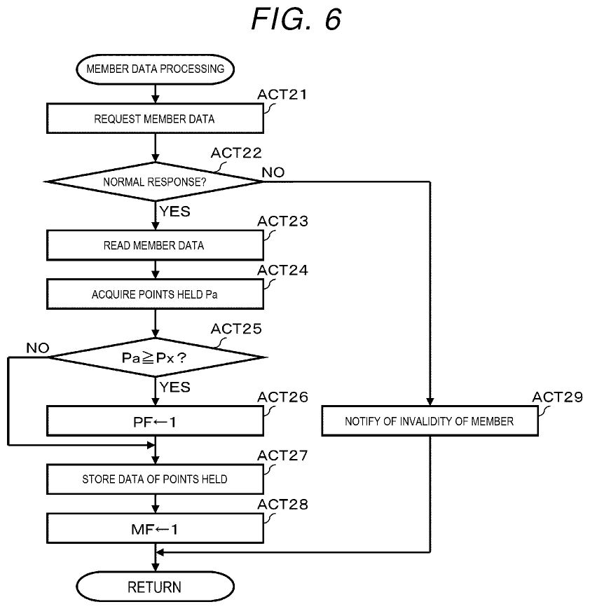

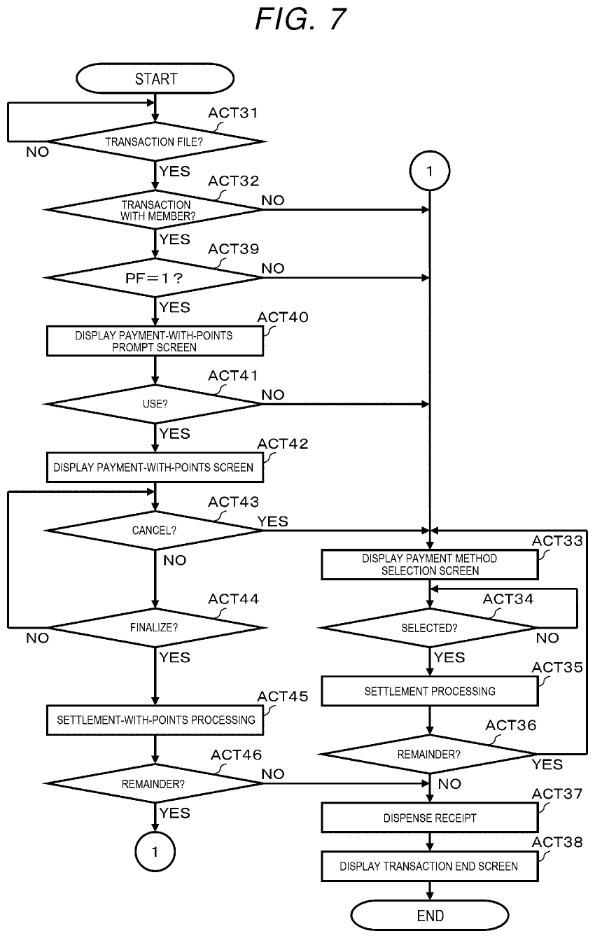

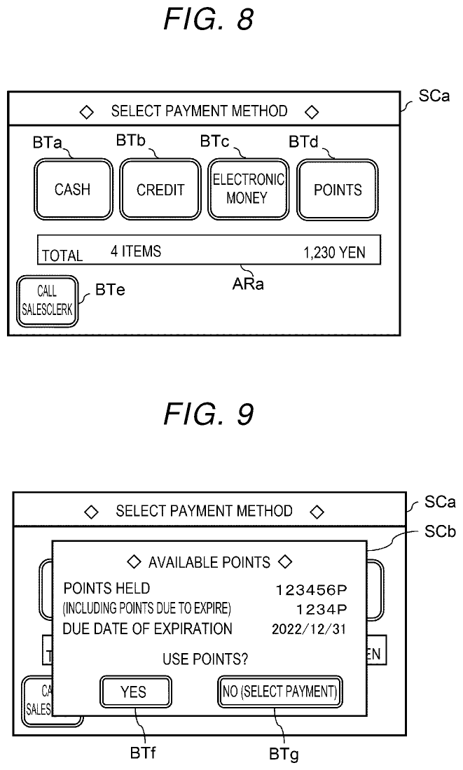

FIG. 5 and FIG. 6 are flowcharts showing procedures of the first information processing executed by the processor 31 of the registration machine 11 according to the registration program. FIG. 7 is a flowchart showing procedures of the second information processing executed by the processor 61 of the payment machine 12 according to the payment program. FIGS. 8 to 10 are an example of the first screen, the second screen, and the third screen displayed on the touch panel 68, which is the display device of the payment machine 12. The first screen is a payment method selection screen SCa. The second screen is a payment-with-points prompt screen SCb. The third screen is a payment-with-points screen SCc. Hereinafter, details of the first information processing and the second information processing will be described, using the drawings. By the way, the procedures of the processing described below are an example. The procedures or the contents of the processing can be suitably changed, provided that similar effects can be achieved.

First, the customer 22 shops on the salesfloor and puts merchandise to be purchased into a shopping basket or the like, and then moves toward a checkout lane when finished shopping. As the customer 22 comes to the checkout lane, the salesclerk 21 performs a declaration operation to start registration to the registration machine 11. In response to this declaration operation, the processor 31 starts the first information processing, the procedures of which are shown in the flowcharts of FIG. 5 and FIG. 6.

The processor 31 in ACT 1 in FIG. 5 resets both a member flag MF and a payment-with-points flag PF to “0”. The member flag MF is 1-bit data for identifying whether the customer 22 is a point member or not. In this embodiment, the member flag MF indicating that the customer is a point member is “1” and the member flag MF indicating that the customer is not a point member is “0”. The payment-with-points flag PF is 1-bit data for identifying whether payment with points is available or not. In this embodiment, the payment-with-points flag PF indicating that payment with points is available is “1” and the payment-with-points flag PF indicating that payment with points is unavailable is “0”. The member flag MF and the payment-with-points flag PF are stored, for example, in a register inside the processor 31. The member flag MF and the payment-with-points flag PF may be stored in the volatile area in the main memory 32.

The processor 31 having finished the processing of ACT 1 causes the touch panel 38 to display a registration screen in ACT 2. The registration screen is a screen where a details area and a total area are arranged. The details area is an area for displaying the merchandise name, the number of items, the unit price, and the amount, of a purchased merchandise, in a list form in order of serial number. However, the items displayed in the details area are not limited to the merchandise name, the number of items, the unit price, and the amount. Another item may be added and one of the items, for example, the amount, may be omitted. The total area is an area for displaying each of the total of the numbers of items (items) and the total of the amounts (yen) displayed in the details area. The items displayed in the total area are not limited to the total of the numbers of items and the total of the amounts. Another item may be added and one of the items, for example, the total of the numbers of items, may be omitted.

The processor 31 having controlled the display of the registration screen proceeds to ACT 3. The processor 31 in ACT 3 determines whether merchandise registration is done or not. A barcode representing a merchandise code, which is identification information of the merchandise, is attached to most items. Thus, the salesclerk 21 operates the scanner 37 to read the barcode attached to the purchased merchandise of the customer 22. As the barcode is read by the scanner 37, the merchandise code of the purchased merchandise is inputted to the registration machine 11. A barcode may not always be attached to some types of merchandise such as fresh food. If a barcode is not attached to the purchased merchandise, the salesclerk 21 touches a merchandise button corresponding to the purchased merchandise on a merchandise keypad displayed on the touch panel 38. As the merchandise button is touched, the merchandise code of the purchased merchandise corresponding to that merchandise button is inputted to the registration machine 11. As the merchandise code of the purchased merchandise is inputted to the registration machine 11, the processor 31 determines that merchandise registration is done.

If it cannot be determined in ACT 3 that merchandise registration is done, the processor 31 proceeds to ACT 4. The processor 31 in ACT 4 examines the member flag MF. If the member flag MF is “0”, the processor 31 proceeds to ACT 5. The processor 31 in ACT 5 determines whether member registration is done or not. If the member ID of a point member is read by the reader 41, the processor 31 determines that member registration is done. If it cannot be determined that member registration is done, the processor 31 returns to ACT 3.

In this way, if the member flag MF is “0”, the processor 31 waits for merchandise registration to be done or for member registration to be done. If it is determined in ACT 5 that member registration is done, that is, if member registration is detected, the processor 31 proceeds to ACT 6. The processor 31 in ACT 6 executes member data processing.

FIG. 6 is a flowchart showing main procedures of the member data processing. As it enters the member data processing, the processor 31 in ACT 21 controls the communication unit 35 to transmit a request command for member data to the server 13. By this control, the request command for member data is transmitted from the communication unit 35 to the server 13 via the network 14. The request command incudes the member ID inputted through member registration.

The server 13 having received the request command searches the member file 15 and acquires the member record 150 describing the member ID included in the request command. Then, the server 13 transmits a normal response command including the data (member ID, points held, points history data) of the member record 150 to the payment machine 12 that is the request command transmission source. However, if the corresponding member record 150 is not acquired from the member file 15, the server 13 transmits an error response command to the payment machine 12 that is the request command transmission source.

The processor 31 having controlled the transmission of the request command waits for a response command from the server 13 in ACT 22. Then, if a normal response command is received within a predetermined time after the request command is transmitted, the processor 31 proceeds to ACT 23. The processor 31 in ACT 23 reads the data of the member record 150 from the normal response command. Moreover, the processor 31 in ACT 24 acquires points held Pa from the data of the member record 150.

The processor 31 in ACT 25 checks whether the points held Pa are equal to or more than threshold points Px, or not. The threshold points Px is a minimum value of points available for the payment of a price. For example, in the case of use where if a member holds at least 1 point, the member can use the point for the payment of a price, the threshold points Px is “1”. For example, in the case of use where a member cannot use points for the payment of a price unless the member has 1000 points, the threshold points Px is “1000”. In this way, the threshold points Px is any value equal to or higher than “1” and what value to employ is decided, for example, based on the use at the store.

If the points held Pa are equal to or more than the threshold points Px in ACT 25, the processor 31 proceeds to ACT 26. The processor 31 in ACT 26 sets the payment-with-points flag PF to “1”. In contrast, if the points held Pa are fewer than the threshold points Px, the processor 31 skips the processing of ACT 26. Therefore, the points held Pa remain “0”.

After finishing or skipping the processing of ACT 26, the processor 31 proceeds to ACT 27. The processor 31 in ACT 27 stores data of points held. The data of points held includes the points held Pa acquired from the member record 150 and the payment-with-points flag PF as of the present time. Also, if there are points to expire, for example, within a month, based on an analysis of the points history data, the data of points held includes the points due to expire and the due date of expiration. The data of points held is stored in a points data memory formed in the volatile memory area in the main memory 32.

After finishing the processing of ACT 27, the processor 31 proceeds to ACT 28. The processor 31 in ACT 28 sets the member flag MF to “1”. Then, the processor 31 exits the member data processing. In this way, if a normal response command is received from the server 13 in response to a request command for member data, the member flag MF turns “1”.

If a normal response command cannot be received from the server 13 within a predetermined time in ACT 22, the processor 31 in ACT 29 notifies that the member ID is invalid. For example, the processor 31 displays a message “Member ID cannot be recognized” on the touch panel 68 and thus notifies that the member ID is invalid. Then, the processor 31 exits the member data processing. In this way, if a normal response command cannot be received from the server 13 in response to a request command for member data, the member flag MF remains “0”.

Referring back to FIG. 5, the description continues.

After exiting the member data processing, the processor 31 returns to ACT 3. Therefore, if the member flag MF turns “1” through the member data processing, the processor 31 in ACT 4 does not proceed to ACT 5 but returns to ACT 3. That is, after a member ID is recognized and data of the point member identified by the member ID is registered, the processor 31 waits for merchandise registration to be performed.

If it is determined in ACT 3 that merchandise registration is done, that is, if merchandise registration is detected, the processor 31 proceeds to ACT 7. The processor 31 in ACT 7 executes merchandise sales data processing. Specifically, the processor 31 searches a merchandise file and acquires merchandise data such as the merchandise name and the unit price, of the merchandise, identified by the merchandise code inputted via the scanner 37 or the touch panel 38. Then, the processor 31 registers merchandise sales data including items such as the merchandise code, the merchandise name, the unit price, the number of items sold, and the amount of sales, into a transaction memory. The transaction memory is a part of the volatile memory area in the main memory 32. The processor 31 updates the data in the details area and the total area on the registration screen, based on the data in the transaction memory.

The processor 31 having finished the merchandise sales data processing checks whether an instruction to output a subtotal is given or not, in ACT 8. An instruction to output a subtotal is given by selecting a subtotal key. The subtotal key may be a hard key arranged on the keyboard 36 or may be a soft key arranged on the registration screen. If an instruction to output a subtotal is not given, the processor 31 returns to ACT 3. The processor 31 repeats the processing of ACT 3 to ACT 7 until an instruction to output a subtotal is given. Therefore, if merchandise registration is performed, the processor 31 executes the merchandise sales data processing. If member registration is performed, the processor 31 execute the member data processing.

After finishing the registration of all the purchased merchandise of the customer 22, the salesclerk 21 selects the subtotal key. As an instruction to output a subtotal is given by selecting the subtotal key, the processor 31 proceeds to ACT 9. The processor 31 in ACT 9 causes the touch panel 38 to display a subtotal screen.

The subtotal screen is a screen where a total area is arranged and where a subtotal price reduction key, a subtotal discount key, a return key, and a payment key are arranged as well. The total area is similar to the total area on the registration screen. The subtotal price reduction key and the subtotal discount key are operating elements selected by the salesclerk 21 to give an instruction to make a price reduction or a discount on the total amount. The return key is an operating element selected by the salesclerk 21 to give an instruction to return to the immediately preceding registration screen. The payment key is an operating element selected by the salesclerk 21 to give an instruction to pay the price. Also, at least one of the subtotal price reduction key, the subtotal discount key, the return key, and the payment key may be a hard key allocated to the keyboard 36.

The salesclerk 21, having checked the subtotal screen, selects the payment key after all the purchased items of the customer 22 have been registered and there is no need for a subtotal price reduction or a subtotal discount. If a subtotal price reduction or a subtotal discount is to be made, the salesclerk 21 selects the subtotal price reduction key or the subtotal discount key. If there is merchandise that is left unregistered, the salesclerk 21 selects the return key.

The processor 31 then checks whether the return key is selected or not, in ACT 10. If the return key is not selected, the processor 31 proceeds to ACT 11. The processor 31 in ACT 11 checks whether the payment key is selected or not. If the payment key is not selected, the processor 31 returns to ACT 10. In this way, in ACT 10 and ACT 11, the processor 31 waits for the return key to be selected or for the payment key to be selected. Also, if the subtotal price reduction key or the subtotal discount key is selected in this waiting state, the processor 31 performs subtotal price reduction processing or subtotal discount processing. Subsequently, the processor 31 returns to the waiting state of ACT 10 and ACT 11.

If the return key is selected by the salesclerk 21 in the waiting state of ACT 10 and ACT 11, the processor 31 returns to ACT 2. That is, the processor 31 returns the screen on the touch panel 38 to the registration screen. Then, the processor 31 executes the processing from ACT 3 onward, as described above.

If the payment key is selected by the salesclerk 21 in the waiting state of ACT 10 and ACT 11, the processor 31 proceeds to ACT 12. The processor 31 in ACT 12 generates a transaction file. That is, the processor 31 generates a data file describing the merchandise sales data and the data of the total number of items and the total amount, and transaction identification data such as the transaction number, the date and time of transaction, and the registration machine ID of each purchased merchandise registered in the transaction memory.

The processor 31 in ACT 13 examines the member flag MF. If the member flag MF is set to “1”, that is, if the settler is registered as a point member, the processor 31 proceeds to ACT 14. The processor 31 in ACT 14 adds the data of points held to the transaction file. If the member flag MF is reset to “0”, that is, if the settler is not registered as a point member, the processor 31 skips the processing of ACT 14. Therefore, the data of points held is not added to the transaction file.

After finishing or skipping the processing of ACT 14, the processor 31 in ACT 15 transmits the data of the transaction file to the payment machine 12. That is, if the settler is registered as a point member, the transaction file with the data of points held is transmitted to the payment machine 12. If the settler is not registered as a point member, the transaction file without the data of points held is transmitted to the payment machine 12.

In this example, the transaction file is transmitted to a payment machine 12 according to one or more of the following rules.

### <Rule 1>

Priority ranks are set for a plurality of payment machines 12 in advance, and the registration machine 11 transmits the transaction file to the payment machine 12 of the highest priority rank. At this time, a payment machine 12 that is able to perform settlement processing receives the transaction file. For example, a payment machine 12 that is in a busy state and therefore unable to perform the settlement processing transfers the transaction file to a payment machine 12 of a lower priority rank.

### <Rule 2>

Each payment machine 12 notifies the registration machine 11 as to whether the respective payment machine 12 is presently in a state of being able or unable to perform settlement processing. The registration machine 11 selects one of the payment machines 12 that is able to perform the settlement processing, based on a predetermined algorithm, and transmits the transaction file to that selected payment machine 12.

### <Rule 3>

Each payment machine 12 notifies the registration machine 11 as to whether the respective payment machine 12 is presently in a state of being able or unable to perform settlement processing. The registration machine 11 displays a list of the payment machines 12 that are presently able to perform the settlement processing on the touch panel 38. Then one of the available payment machines 12 is designated from the list by an operation of the salesclerk 21, and the transaction file is transmitted to the payment machine 12 designated by the sales clerk.

The rules to decide the destination for the transaction file are not limited to the foregoing rules 1, 2, 3. In other examples, the destination for the transaction file may be decided according to another rule.

The processor 31 having finished the transmission of the transaction file proceeds to ACT 16. The processor 31 in ACT 16 displays information representing the payment machine 12 that is the destination of transmission of the transaction file, on the touch panel 38. Then, the processor 31 ends the first information processing.

Here, the processor 31 executes the processing of ACT 3 and ACT 7 in FIG. 5 in cooperation with the keyboard 36, the scanner 37 or the touch panel 38 and thus implements the function of the merchandise registration unit 311. The processor 31 executes the processing of ACT 5 and ACT 6 in FIG. 5, specifically the processing of ACT 21 to ACT 28 in FIG. 6, in cooperation with the reader 41, and thus implements the function of the member registration unit 312. The processor 31 executes the processing of ACT 11 to ACT 15 in FIG. 5 in cooperation with the communication unit 35 and thus implements the function of the transaction output unit 313.

The salesclerk 21 having pressed the payment key then instructs the customer 22 to pay the price at the payment machine 12 indicated by the information displayed on the touch panel 38. The customer 22 moves to the place where the payment machine 12 designated by the salesclerk 21 is installed, and operates the payment machine 12 to pay for the purchased merchandise.

The processor 61 of the payment machine 12 starts the second information processing, the procedures of which are shown in the flowchart of FIG. 7, after finishing a sales transaction with a previous customer. The processor 61 in ACT 31 waits for the input of a transaction file. If the processor 61 receives a transaction file via the communication unit 65, the processor 61 proceeds to ACT 32. The processor 61 in ACT 32 checks whether it is a sales transaction with a point member or not. That is, if data of points held is added to the transaction file, the processor 61 acknowledges that it is a sales transaction with a point member. If data of points held is not added to the transaction file, the processor 61 acknowledges that it is not a sales transaction with a point member.

If it is not a sales transaction with a point member, the processor 61 proceeds to ACT 33. The processor 61 in ACT 33 causes the touch panel 68 to display the payment method selection screen SCa (see FIG. 8).

FIG. 8 is a schematic view showing a display example of the payment method selection screen SCa. In this embodiment, the payment method selection screen SCa is a screen where a cash button BTa, a credit button BTb, an electronic money button BTc, a point button BTd, and a salesclerk call button BTe are arranged. Also, the payment method selection screen SCa includes a display area ARa for the total number of items and the total amount. The cash button BTa is an operating element selected by the customer 22 to designate payment by cash. The credit button BTb is an operating element selected by the customer 22 to designate payment by credit card. The electronic money button BTc is an operating element selected by the customer 22 to designate payment by electronic money. The point button BTd is an operating element selected by the customer 22 to designate payment with points held. The salesclerk call button BTe is an operating element selected by the customer 22 to call a salesclerk.

The payment method is not limited to these four types of payment: cash, credit card, electronic money, and points. In some examples, only two or three types may be available and/or another payment method besides these may be available. The payment method selection screen SCa is thus a screen for accepting the selection of a payment method from among a plurality of payment methods. Here, the processor 61 executes the processing of ACT 33 in cooperation with the touch panel 68 and thus implements the function of the first display unit 611.

The customer 22 having reviewed the payment method selection screen SCa selects a button corresponding to the desired payment method. That is, the customer 22 wanting to pay by cash selects the cash button BTa. The customer 22 wanting to pay by credit card selects the credit button BTb. The customer 22 wanting to pay by electronic money selects the electronic money button BTc. The customer 22 wanting to pay with points selects the point button BTd.

The processor 61 having turned the screen on the touch panel 68 into the payment method selection screen SCa waits for a payment method to be selected from among the plurality of payment methods, in ACT 34. Then, once a payment method is selected, the processor 61 proceeds to ACT 35. The processor 61 in ACT 35 executes settlement processing by the selected payment method.

If the cash button BTa is selected, the processor 61 executes cash settlement processing. The cash settlement processing is processing of subtracting the total amount due for the transaction from the amount of cash paid (that is, the total amount of cash put into the automatic change machine) and providing change back as necessary. If the credit button BTb is selected, the processor 61 executes credit card settlement processing. The credit card settlement processing is processing of executing authentication of a credit card read by the reader-writer 70 and subtracting the total amount due from the amount paid by the credit card after the credit card is approved/authenticated. If the electronic money button BTc is selected, the processor 61 executes electronic money settlement processing. The electronic money settlement processing is processing of subtracting the total amount due from the amount paid via the electronic money medium as read by the reader-writer 70. If the point button BTd is selected, the processor 61 execute settlement-with-points processing. The settlement-with-points processing is processing of subtracting the total amount due from the amount paid via converting accumulated points into cash value at a predetermined rate of conversion.

After finishing the settlement processing in ACT 35, the processor 61 proceeds to ACT 36. The processor 61 in ACT 36 checks whether there is still a remainder (balance due) of the total amount after the amount paid is processed. That is, for example, if the electronic money or points balance was insufficient to meet the total amount due. If there is a remainder, the processor 61 returns to ACT 33. That is, the processor 61 causes the touch panel 68 to display the payment method selection screen SCa again and waits for a payment method to be selected. At this time, the total amount included in the display area ARa is the remainder (balance due).

If there is no remainder of the total amount in ACT 36, the processor 61 proceeds to ACT 37. The processor 61 in ACT 37 controls the printing and dispensing of a transaction receipt from the printer 69. The transaction number, the date and time of transaction, the registration machine ID, the merchandise sales data, the total number of items, the total amount and the like described in the transaction file are printed on the transaction receipt. As the transaction receipt is being dispensed, the processor 61 proceeds to ACT 38. The processor 61 in ACT 38 turns the screen on the touch panel 68 into a transaction end screen. The transaction end screen is not particularly limited to any type but is preferably a screen displaying guidance that is useful at the end of the transaction, for example, “Mind you don't forget to take the receipt” or the like. With that, the processor 61 ends the second information processing for settling the sales transaction with the customer 22 who is not a point member.

In this way, when a customer 22 who is not a point member moves to the payment machine 12, the payment method selection screen SCa is displayed on the touch panel 68. Therefore, the customer 22 selects a desired payment method and pays by that payment method, and thus can settle the sales transaction by self-service.

If, in ACT 32, data of points held is added to the transaction file and therefore it can be determined that the transaction is a sales transaction with a point member, the processor 61 proceeds to ACT 39. The processor 61 in ACT 39 examines the payment-with-points flag PF of the data of points held. If the payment-with-points flag PF is “0”, that is, if it is a sales transaction with a point member who cannot use payment with points because the points held Pa are fewer than the threshold points Px, the processor 61 returns ACT 33. That is, the processor 61 turns the screen on the touch panel 68 into the payment method selection screen SCa. Subsequently, the processor 61 executes the processing of ACT 34 to ACT 38 similarly to the foregoing description.

In this way, in the case of the customer 22 who is a point member but presently cannot use payment with points because the points held Pa are fewer than the threshold points Px (for example, a customer 22 whose points held Pa is “0”), the screen on the touch panel 68 turns to the payment method selection screen SCa. The customer 22 selects a desired payment method from the payment method selection screen SCa and pays by that payment method. By doing so, the customer 22 can settle the sales transaction by self-service.

If the payment-with-points flag PF is “1” in ACT 39, that is, if it is a sales transaction with a point member who can use payment with points (e.g., a customer 22 with a points held Pa equal to or greater than the threshold points Px), the processor 61 proceeds to ACT 40. The processor 61 in ACT 40 causes the touch panel 68 to display the payment-with-points prompt screen SCb (see FIG. 9).

FIG. 9 is a schematic view showing a display example of the payment-with-points prompt screen SCb. In this embodiment, the payment-with-points prompt screen SCb shows information about the points held, the number of points due to expire, and the due date of expiration included in the data about the points held. Also, the payment-with-points prompt screen SCb shows a “Yes” button BTf designating an intention to make a payment with points and a “No” button BTg designating an intention not to make a payment with points.

The payment-with-points prompt screen SCb is displayed, in this example, superimposed on the payment method selection screen SCa, as shown in FIG. 9. That is, the payment-with-points prompt screen SCb is displayed in the form of a pop-up window on the touch panel 68.

In this way, the payment-with-points prompt screen SCb is an example of a screen for accepting a designation about whether or not to use payment with points. Here, the processor 61 executes the processing of ACT 40 in cooperation with the touch panel 68 and thus implements the function of the second display unit 612.

The customer 22 having reviewed the payment-with-points prompt screen SCb selects the “Yes” button BTf or the “No” button BTg.

The processor 61 then checks whether the use of payment with points is designated or not, in ACT 41. If it is detected that the “Yes” button BTf is selected, the processor 61 determines that the use of payment with points is designated. If it is detected that the “No” button BTg is selected, the processor 61 determines that the use of payment with points is not designated.

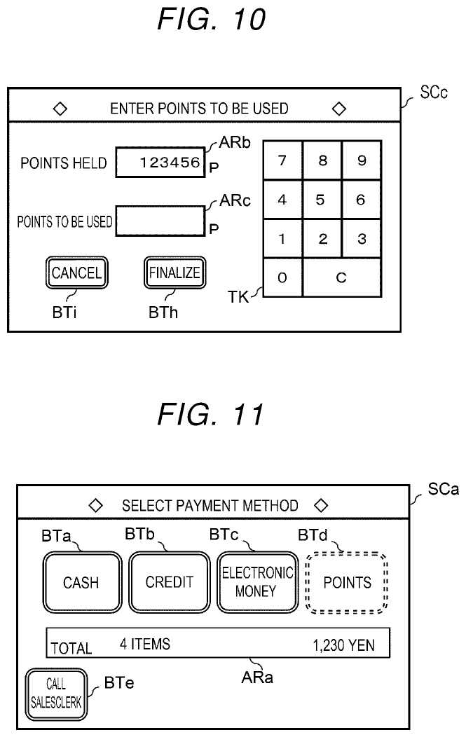

If the use of payment with points is designated in ACT 41, that is, if the “Yes” button BTf is selected, the processor 61 proceeds to ACT 42. The processor 61 in ACT 42 causes the touch panel 68 to display the payment-with-points screen SCc (see FIG. 10).

FIG. 10 is a schematic view showing a display example of the payment-with-points screen SCc. In this embodiment, the payment-with-points screen SCc is a screen where a display area ARb for the points held, a display area ARc for the points to be used, a numeric keypad TK for inputting the points to be used, a finalize button BTh, and a cancel button BTi are arranged. In the display area ARb, the points held included in the data of points held is displayed. In the display area ARc, the points to be used inputted by an operation on the numeric keypad TK is displayed. Also, the points to be used is any value equal to or lower than the points held. Points to be used exceeding the points held cannot be inputted. The finalize button BTh is an operating element selected by the customer to designate the finalization of the points to be used. The cancel button BTi is an operating element selected by the customer to designate the cancellation of payment with points.

In this way, the payment-with-points screen SCc is an example of a screen accepting payment based on payment with points. Here, the processor 61 gives a YES determination in ACT 41 and executes the processing of ACT 42 in cooperation with the touch panel 68, and thus implements the function of the third display unit 613.

The processor 61 then checks whether the cancel button BTi is selected or not, in ACT 43. If the cancel button BTi is not selected, the processor 61 proceeds to ACT 44. The processor 61 in ACT 44 checks whether the finalize button BTh is selected or not. If the finalize button BTh is not selected, the processor 61 returns to ACT 43. In this way, in ACT 43 and ACT 44, the processor 61 waits for the cancel button BTi or the finalize button BTh to be selected.

If the cancel button BTi is selected in the waiting state of ACT 43 and ACT 44, the processor 61 returns to ACT 33. That is, the processor 61 clears the payment-with-points screen SCc and turns the screen on the touch panel 68 into the payment method selection screen SCa. Subsequently, the processor 61 executes the processing of ACT 34 to ACT 38 similarly to the previous description.

In this way, if a customer 22 who is a point member that can use payment with points declares the use of payment with points but then selects the cancel button BTi on the payment-with-points screen SCc the screen on the touch panel 68 shifts (returns) to the payment method selection screen SCa. The customer 22 then selects a desired payment method from the payment method selection screen SCa and pays for the purchased merchandise by that payment method. By doing so, the customer 22 can settle the sales transaction by self-service.

If the finalize button BTh is selected in the waiting state of ACT 43 and ACT 44, the processor 61 proceeds to ACT 45. The processor 61 in ACT 45 executes the settlement-with-points processing. The settlement-with-points processing is processing of subtracting the total amount due from the amount paid as acquired by converting the points to be used as inputted in the display area ARc into cash at a predetermined rate of conversion.

After finishing the settlement-with-points processing of ACT 45, the processor 61 proceeds to ACT 46. The processor 61 in ACT 46 checks whether there is a remainder of the total amount because the amount paid with points was insufficient. If there is a remainder, the processor 61 returns to the ACT 33. That is, the processor 61 changes the screen on the touch panel 68 to the payment method selection screen SCa. At this time, the total amount in the display area ARa will be the remainder (amount still due). Subsequently, the processor 61 executes the processing of ACT 34 to ACT 38 similarly to the previous description.

Thus, a customer 22 who is a point member without sufficient points (or alternatively not applying sufficient points) to cover the entire transaction amount can pay the remainder balance by another payment method and thus can settle the sales transaction by self-service.

If there is no remainder in ACT 46, the processor 61 proceeds to the ACT 37. The processor 61 controls the printing and dispensing of a transaction receipt by the printer 69. Also, the processor 61 turns the screen on the touch panel 68 into the transaction end screen. With that, the processor 61 ends the second information processing for settling the sales transaction with the customer 22 who is a point member.

In this way, when the customer 22 who is a point member and can use payment with points moves to the payment machine 12, the payment-with-points prompt screen SCb is displayed on the touch panel 68. Thus, the customer 22 finds it easier to use payment with points and therefore comes to use payment with points actively.

If the use of payment with points is not designated in ACT 41, that is, if the “No” button BTg is selected, the processor 61 proceeds to ACT 33. That is, the processor 61 turns the screen on the touch panel 68 into the payment method selection screen SCa. Subsequently, the processor 61 executes the processing of ACT 34 to ACT 38 similarly to already described.

The payment method selection screen SCa is an example of the first screen for accepting the selection of a payment method from among a plurality of payment methods. Here, the processor 61 gives a NO determination in ACT 41 and executes the processing of ACT 33 in cooperation with the touch panel 68, and thus implements the function of the fourth display unit 614.

In this way, even in the case of the customer 22 who is a point member, if the customer 22 does not want to use payment with points, the screen on the touch panel 68 turns to the payment method selection screen SCa. The customer 22 selects a desired payment method from the payment method selection screen SCa and pays for the purchased merchandise by that payment method. By doing so, the customer 22 can settle the sales transaction by self-service.

Effects of Payment Machine

As described above in detail, when the customer 22 who can use payment with points moves to the payment machine 12, the payment-with-points prompt screen SCb is displayed on the touch panel 68. Therefore, it is assumed that the customer 22 actively uses payment with points. Also, the payment-with-points prompt screen SCb is displayed in the form of a pop-up window. Therefore, the customer 22 can be strongly prompted to use payment with points. Consequently, the frequency of use of payment with points increases and therefore the store's demand that payment with points should be used to the utmost can be satisfied.

A customer 22 who does not want to use payment with points selects the “No” button BTg on the payment-with-points prompt screen SCb. Then, the screen on the touch panel 68 shifts to the payment method selection screen SCa. Therefore, the customer 22 can always pay by a particularly desired payment method.

### Modification Examples

If the payment-with-points flag PF is reset to “0” in ACT 39 (see FIG. 7) or if the “No” button BTg on the payment-with-points prompt screen SCb is selected in ACT 41, the customer 22 does not use payment with points. Therefore, the point button BTd on the payment method selection screen SCa may be erased or grayed out and thus invalidated, as shown in FIG. 11.

The payment machine 12 is not limited to a payment machine as used in a semi-self-service-type checkout system. For example, the functions of the first display unit 611, the second display unit 612, the third display unit 613, and the fourth display unit 614 may be incorporated in a POS terminal in a full-self-service-type checkout system (a so-called self-service POS terminal), thus forming a payment machine that can prompt the use of payment with points at a full-self-service-type POS terminal. In this case, the input unit is an input device of the self-service POS terminal, for example, a scanner, a keyboard, a touch panel or the like. The display unit is the display of the self-service POS terminal.

In an embodiment, the member is a point member and the member-specific payment method is payment with points. Examples are not limited to a point member of a points-based customer loyalty program. For example, a customer who owns a store-specific credit card, a store-sponsored credit card, or the like (may be referred to variously as a “store card,” a “store charge card,” or a “store account card”) is the settler, it may be preferable to prompt the customer to make payment using the store card. Thus, in this context, the membership type of relevance would be a credit card member and the member-specific payment method would be payment by store card. In that case, the second display unit displays a use selection screen for the store card.

While certain embodiments have been described, these embodiments are presented by way of example only, and are not intended to limit the scope of the present disclosure. The novel embodiments can be implemented in various other forms and various omissions, substitutions and modifications can be made without departing from the spirit of the present disclosure. Such embodiments and modifications thereof are included in the scope and spirit of the disclosure, and are included in the claims and equivalents of thereof.

What is claimed is:

1. A payment machine, comprising:
a display screen for displaying screens related to settlement of a sales transaction to a customer; and
a processor connected to the display screen and configured to:
receive settlement data relating to a sales transaction,
control the display screen to display a first screen for accepting a selection of a payment method from among a plurality of payment methods if the settlement data indicates the customer cannot use a member-specific payment method,
control the display screen to display a second screen for accepting a designation to use the member-specific payment method or not if the settlement data indicates the customer can use the member-specific payment method,
control the display screen to display a third screen for accepting payment by the member-specific payment method if the customer designates use of the member-specific payment method on the second screen, and
control the display screen to display the first screen if the customer designates not to use the member-specific payment method on the second screen.

2. The payment machine according to claim 1, wherein the second screen is displayed superimposed on the first screen.

3. The payment machine according to claim 1, wherein the second screen is a pop-up window displayed over the first screen.

4. The payment machine according to claim 1, wherein a button for selecting the member-specific payment method is grayed out on the first screen when the settlement data indicates the customer cannot use a member-specific payment method.

5. The payment machine according to claim 1, wherein the member-specific payment method is payment by using points from a customer loyalty program account associated with the customer.

6. The payment machine according to claim 1, further comprising:
a communication interface connected to at least one registration terminal, wherein
the settlement data is received via the communication interface from the registration terminal.

7. The payment machine according to claim 1, further comprising:
an automatic change machine interface connectable to a change machine for receiving cash payments and returning change for settling of the sales transaction.

8. The payment machine according to claim 1, further comprising:
a card reader-writer for receiving payments via a credit card or a pre-paid electronic money card.

9. The payment machine according to claim 8, wherein the member-specific payment method is a store-sponsored credit card or a store charge card.

10. A non-transitory, computer-readable medium storing program instructions which when executed by a processor of a payment machine causes the payment machine to perform a method comprising:
receiving settlement data relating to a sales transaction;
controlling a display screen to display a first screen for accepting a selection of a payment method from among a plurality of payment methods if the settlement data indicates the customer cannot use a member-specific payment method;
controlling the display screen to display a second screen for accepting a designation to use the member-specific payment method or not if the settlement data indicates the customer can use the member-specific payment method;
controlling the display screen to display a third screen for accepting payment by the member-specific payment method if the customer designates use of the member-specific payment method on the second screen; and
controlling the display screen to display the first screen if the customer designates not to use the member-specific payment method on the second screen.

11. The non-transitory, computer-readable medium according to claim 10, wherein the second screen is displayed superimposed on the first screen.

12. The non-transitory, computer-readable medium according to claim 10, wherein the second screen is a pop-up window displayed over the first screen.

13. The non-transitory, computer-readable medium according to claim 10, wherein a button for selecting the member-specific payment method is grayed out on the first screen when the settlement data indicates the customer cannot use a member-specific payment method.

14. The non-transitory, computer-readable medium according to claim 10, wherein the member-specific payment method is payment by using points from a customer loyalty program account associated with the customer.

15. The non-transitory, computer-readable medium according to claim 10, wherein the settlement data is received via a communication interface from a registration terminal.

16. The non-transitory, computer-readable medium according to claim 10, the method further comprising:
controlling a change machine for receiving cash payments and returning change for settling of the sales transaction.

17. The non-transitory, computer-readable medium according to claim 10, the method further comprising:
controlling a card reader-writer for receiving payments via a credit card or a pre-paid electronic money card.

18. The non-transitory, computer-readable medium according to claim 10, wherein the member-specific payment method is a store-sponsored credit card or a store charge card.
